(19) United States
(12) Patent Application Publication
(10) Pub. No.: US 2004/0177538 A1
(43) Pub. Date: Sep. 16, 2004

(54) Solar powered sign light

(76) Inventors: Brent K. De Ruyter, Simi Valley, CA (US); Jerry D. Lowe, Woodland Park, CO (US)

Correspondence Address: BRENT DE RUYTER, 790 COPPERTREE COURT, SIMI VALLEY, CA, 93065, US

(21) Appl. No.: 10/387,662

(22) Filed: Mar. 14, 2003

(51) Int. Cl. G09F 13/02

(52) U.S. Cl. 40/559; 40/607.05; 40/606.18

(57) ABSTRACT

A lightweight, portable, reliable and functionally self-contained device for illuminating a sign is disclosed. The portable illuminated sign has particular application by realtors when selling real estate property, which has been listed. A method of onsite advertising and promotion of property available for sale comprising the steps of: providing an illuminated sign having a opaque or translucent face, a solar cell to generate power, a battery to store power, a lamp bulb, and a photo cell to turn power on to the lamp bulb in low ambient light; positioning the sign in a prominent location so that it can be viewed by passers by; and, removing the sign subsequent to sale of the property.

In a preferred embodiment of the invention the sign comprises a duration control to specify duration of illumination after the photocell has turned on power to the lamp bulb. Multiple lamp bulbs as well as sign components are enclosed within a housing having translucent opposite side portions. This device has the adaptability to be installed onto existing signs.

### FIELD OF THE INVENTION

This invention relates to on site business advertising. More particularly this invention relates to a solar powered light for outside signs, which has particular applicability in on site advertisement of real estate.

### BACKGROUND OF THE INVENTION

Realtors use their corporate signs to identify property that is listed for sale. Potential buyers, which may incidentally drive by the property, are alerted to its availability. More importantly potential buyers which have read advertisements and who wish to view a property of particular interest rely on these signs to locate the property. A lighted sign is visible after dusk. During fall, winter, and spring evenings an illuminated sign is particularly valuable in locating an unknown house on a given street. Most individuals would prefer to drive several blocks more than to stop and exit their vehicle a number of times to walk up to doors of unknown houses to ascertain their street number.

The problem is that in the real estate industry where there is a great need for an illuminated sign, it is not practical to have such a sign. The requirement and need for an illuminated sign is sudden and temporary. It is not practical to hard wire such an illuminated sign. What is needed is a portable lighted sign which is light to carry and convenient to set up and remove. What is needed is a lighted sign that a woman could readily remove from a trunk of her vehicle and position while dressed in business attire. What is needed is an illuminated sign that is consistently reliable and which is self-contained without any external depleting source of power.

### OBJECTS OF THE INVENTION

It is an object of this invention to disclose an improved method of on site advertisement and identification of listed real estate. It is an object of this invention to disclose a lightweight, reliable and truly portable illuminated sign or the capacity to illuminate an existing sign. It is yet a further objective of this invention to disclose an improved method of on site advertisement of real estate property that is listed for sale.

One aspect of this invention provides for a method of display comprising the steps of: Providing an device for illuminating sign having a single and double face, a solar cell to generate power, a battery to store power, a lamp bulb, and a photo cell to turn power on to the lamp bulb in low ambient light; and, positioning the sign in a prominent location so that it can be viewed by adjacent traffic.

In a preferred aspect of this invention a method of on site advertising and promotion of property available for sale comprising the steps of: Providing an device to illuminate a sign, a solar cell to generate power, a battery to store power, a lamp bulb, and a photo cell to turn power on to the lamp bulb in low ambient light; positioning the sign in a prominent location so that it can be viewed by passers by; and removing the sign subsequent to sale of the property.

Various other objects, advantages and features of this invention will become apparent to those skilled in the art from the following description in conjunction with the accompanying drawings.

### FIGURES OF THE INVENTION

FIG. 1 is a perspective view of an illuminated realtor's sign positioned in front of a house, which is listed for sale.

FIG. 2 is a cross sectional view taken along line 2-2 on FIG. 1.

FIG. 2 shows the interior of the sign housing.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

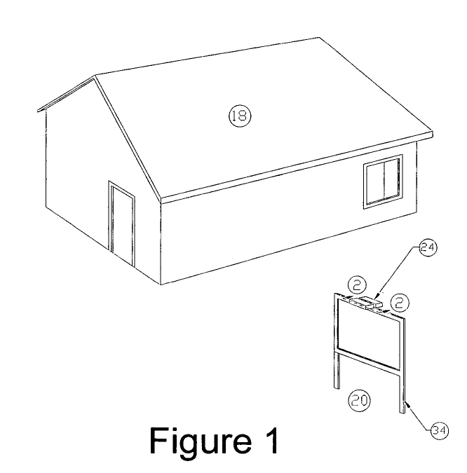

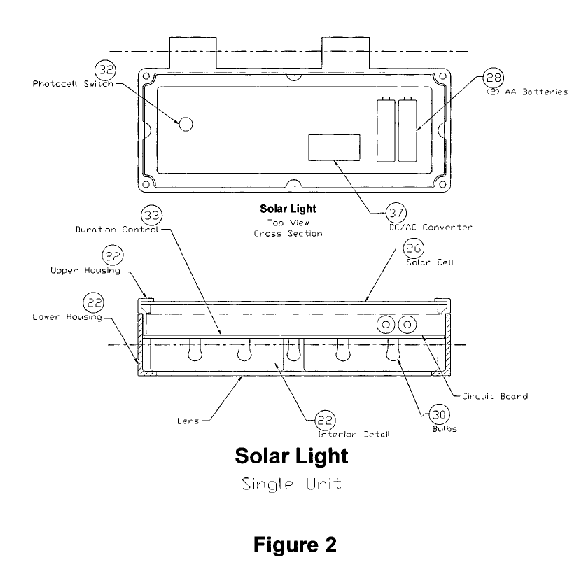

Turning now to the drawings and more particularly to FIG. 1 we have a perspective view of an illuminated realtor's sign (20) positioned prominently on property (18), which is listed for sale. FIG. 2 is a cross sectional view taken along line (2-2) on FIG. 1. FIG. 2 shows the interior of the sign housing (22). A method of display comprises the steps of: Providing an illuminated sign (20), a solar cell (26) to generate power, a battery (28) to store power, a lamp bulb (30), and a photo cell (32) to turn power on to the lamp bulb in low ambient light; and, positioning the sign in a prominent location so that it can be viewed by adjacent traffic.

The sign (20) has particular application in promoting short-term events where its use is for a period of short duration. A method of advertising and promoting a short-term event is similar to the method above but further comprises the step of removing the sign (20) subsequent to the completion of the event. It is believed that the sign (20) will be most valuable to realtors who have listed property (18) for sale. Such property (18) typically is on the market only for a short term. A method of on site advertising and promotion of property (18) available for sale comprises the steps of: a) providing an illuminated sign (20), a solar cell to generate power (26), a battery (28) to store power, a lamp bulb (30), and a photo cell (32) to turn power on to the lamp bulb (30) in low ambient light; b) positioning the sign (20) in a prominent location so that it can be viewed by passers by; and, c) removing the sign (20) subsequent to sale of the property (18).

Most preferably the sign (20) has both a front and rear face (24) so that it displays from both front and rear portions. In the most preferred embodiment of the invention the sign (20) further comprises a control (33) to specify the duration of illumination after the photo cell (32) has turned on power on the lamp bulb (30). A housing (22) encloses the solar cell (26), the battery (28), the lamp bulb (30), and the photocell (32). The housing may contain the duration control (33) as well as a DC/AC converter (37).

In the most preferred embodiment of the invention the sign (20) comprises legs (34), which hinge open to support the sign 20 in an elevated position. The lamp bulb (30) comprises multiple bulbs (30) spaced within the housing (22).

While the invention has been described with preferred specific embodiments thereof, it will be understood that this description is intended to illustrate and not to limit the scope of the invention, which is defined by the following claims.

1) A method of display comprising the steps of: providing an illuminating device for signs having a translucent or opaque face, a solar cell to generate power, a battery to store power, a lamp bulb, and a photo cell to turn power on to the lamp bulb in low ambient light; and, positioning the sign in a prominent location so that it can be viewed by adjacent traffic.

2) A method of advertising and promoting a short-term event as in claim 1 further comprising the step of removing the sign subsequent to the completion of the event.

3) A method of on site advertising and promotion of property available for sale comprising the steps of: providing an illuminating device for signs having a opaque or translucent face, a solar cell to generate power, a battery to store power, a lamp bulb, and a photo cell to turn power on to the lamp bulb in low ambient light; positioning the sign in a prominent location so that it can be viewed by passer by; and removing the sign subsequent to sale of the property.

4) A method as in claim 3 wherein the sign has a front and rear opaque or translucent face so that it displays from both front and rear side portions.

5) A method as in claim 3 wherein the sign further comprises a duration control to specify the duration of illumination after the photocell has turned on power to the lamp bulb.

6) A method as in claim 5 wherein the sign further comprises a housing that internally contains the solar cell, the battery, the lamp bulb, and the photocell.

7) A method as in claim 6 wherein the sign further comprises legs that hinge open to support the sign in an elevated position.

8) A method as in claim 5 wherein the lamp bulb comprises multiple bulbs spaced within the sign.

9) A method as in claim 8 wherein the lamp bulb comprises an incandescent or florescent lamp to illuminate relative to power consumption.

10) A method as in claim 1 wherein the illuminating device can be attached to an existing sign. This attachment will allow existing signs to be fitted with this illuminating device.

11) A method as in claim 1 wherein the illuminating device can be installed in multiples to illuminate a large existing sign. This allows the illuminating device to be installed on existing billboards.
